(19) United States
(12) Patent Application Publication
(10) Pub. No.: US 2011/0073410 A1
(43) Pub. Date: Mar. 31, 2011

(54) Swimming Pool Ladder With a Barrier

(75) Inventor: Hua Hsiang Lin, Xiamen (CN)

(73) Assignee: INTEX RECREATION CORP., Long Beach, CA (US)

(21) Appl. No.: 12/853,668

(22) Filed: Aug. 10, 2010

(30) Foreign Application Priority Data
Aug. 11, 2009 (CN) 200920182572.0
Aug. 11, 2009 (CN) 200920182573.5
Aug. 11, 2009 (CN) 200920182578.8
Aug. 11, 2009 (CN) 200920182579.2

(51) Int. Cl. E06C 1/02; E06C 7/50; E06C 7/00

(52) U.S. Cl. 182/118

(57) ABSTRACT

The present disclosure provides a swimming pool ladder with a barrier. The ladder includes two ladder sections. A top platform for supporting is connected between the upper portions of the two ladder sections and disposed above the swimming pool. The two ladder sections are respectively positioned inside and outside the swimming pool. The ladder section includes two parallel-disposed rails and a plurality of steps. The plurality of steps are mounted at intervals along the two rails from top to bottom. A barrier is provided that is perpendicular to the inner side face of the first ladder section. The barrier has a triangle shape, one edge of which is adjacent the inner side face of the first ladder section and fixed on at least two steps through at least two connectors and another edge is adjacent the inner sidewall of the swimming pool. The top end of the barrier is spaced from the top platform by a distance and the bottom end is adjacent the floor of the swimming pool.

### CROSS-REFERENCE TO RELATED APPLICATIONS

This application claims priority to Chinese Patent Application No. 200920182573.5, filed on Aug. 11, 2009; Chinese Patent Application No. 200920182579.2, filed on Aug. 11, 2009; Chinese Patent Application No. 200920182572.0, filed on Aug. 11, 2009; Chinese Patent Application No. 200920182578.8, filed on Aug. 11, 2009, the entire disclosures of which are hereby incorporated by reference.

### FIELD OF THE INVENTION

The present invention relates to swimming pool equipment, in particular to a swimming pool ladder.

### BACKGROUND AND SUMMARY OF THE INVENTION

In a prior design as shown in FIG. 1, a barrier 1′ is positioned on a lower portion of a first ladder section. Existing barrier 1′ extends from a top platform 2′ of the ladder to a floor 3′ of the swimming pool.

According to the present disclosure, a swimming pool ladder with a barrier is provided that comprises first and second ladder sections being positionable inside and outside a swimming pool. The first ladder section includes a plurality of steps including an uppermost step. The ladder further includes a top support platform connecting upper portions of the first and second ladder sections, and a triangular barrier having a first edge position adjacent the first ladder section and fixed to at least two steps with at least two connectors and a bottom edge positionable adjacent an inner sidewall of the swimming pool. A top end of the barrier is spaced apart from the top platform by a distance.

### BRIEF DESCRIPTION OF THE DRAWINGS

The above-mentioned and other features and advantages of the invention, and the manner of attaining them, will become more apparent and the disclosure itself will be better understood by reference to the following description taken in conjunction with the accompanying drawings, wherein:

FIG. 1 is a view showing prior swimming pool ladder with a barrier;

FIG. 2 an exploded view of a swimming pool ladder with a barrier according to the present disclosure;

FIG. 3A is an enlarged view of a fixed-type connector piece of the present disclosure;

FIG. 3B is a view illustrating the mounting of the fixed-type connector of FIG. 3A;

FIG. 4A an exploded view of a swing-type connector of the present disclosure;

FIG. 4B is an assembled view of the swing-type connector;

FIG. 4C is a view illustrating the mounting of the swing-type connector;

FIG. 4D is an enlarged exploded view of the swing-type connector;

FIG. 5 is a view illustrating the application of the present ladder with barrier in an inflatable swimming pool; and

FIG. 6 is a view illustrating the application of the present ladder with barrier in a framed swimming pool.

Corresponding reference characters indicate corresponding parts throughout the several views. Although the drawings represent embodiments of the present invention, the drawings are not necessarily to scale and certain features may be exaggerated in order to better illustrate and explain the present invention.

### BRIEF DESCRIPTION OF THE APPENDICES

Attached Appendix A includes details of means for fixing a ladder to a swimming pool. Attached Appendix B includes details on a ladder barrier. Attached Appendix C includes details on a ladder baffle. Appendices A, B, and C are incorporated by reference herein.

### DETAILED DESCRIPTION OF THE PREFERRED EMBODIMENTS

The embodiments disclosed below are not intended to be exhaustive or limit the invention to the precise forms disclosed in the following detailed description. Rather, the embodiments are chosen and described so that others skilled in the art may utilize their teachings.

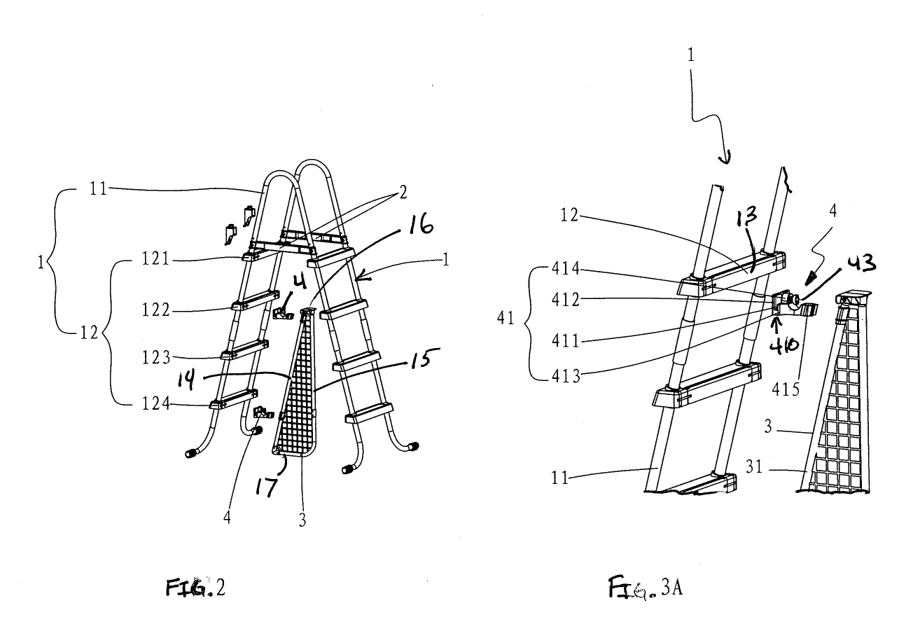

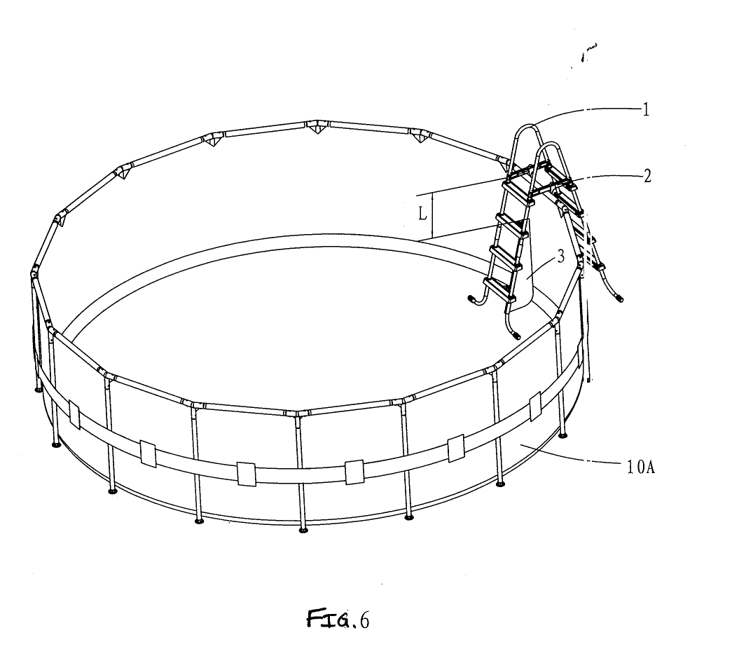

As shown in FIG. 2, with reference also to FIG. 5, the present disclosure provides a swimming pool ladder 1 with a barrier 3. Ladder 1 includes two parallel rails 11 and four steps 12. When positioned in a pool 10, an inner or first section of ladder 1 is positioned within pool 10 and an outer or second section is positioned outside of pool 10. Ladder 1 further includes a top platform 2 (ladders without a platform are shown in FIGS. 2, 3B, 4C, 5, and 6′) for supporting a person connected between the upper portions of rails 11 and positioned above the inflatable swimming pool 10 as shown in FIG. 5. As shown in FIG. 6, the manner in which barrier 3 is mounted to ladder 1 in a frame swimming pool 10A is the same as that in inflatable swimming pool 10.

Steps 12 are mounted at intervals between the two rails 11 from top to bottom. The step 12 closest to top platform 2 is an uppermost or first step 121. The other steps 12 are respectively a second step 122, a third step 123, and a bottommost or fourth step 124. Barrier 3 is perpendicular to an inner side face 13 of ladder 1 positioned in pool 10. Barrier 3 has a triangle shape, one edge 14 of which is adjacent inner side face 13 of ladder 1 and fixed on second step 122 and fourth step 124 through connecting pieces 4, and another edge 15 of which is adjacent the inner sidewall of swimming pool 10.

As shown in FIG. 5, a top end 16 of barrier 3 is spaced from top platform 2 by a certain distance L, which distance L is preferably larger than the interval of two steps 12. The bottom end of the barrier 3 is parallel to floor 101 of swimming pool 10, with a gap formed therebetween. The gap is sized as to not to allow a child to penetrate therethrough.

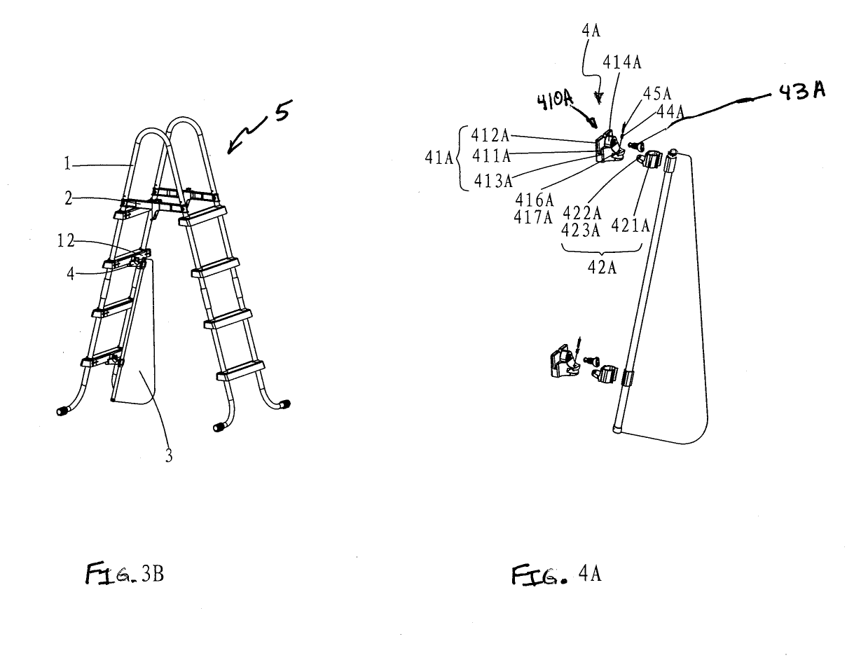

As shown in FIG. 3A, a connector piece 4 is preferably a fixed-type connector 4. Fixed-type connectors 4 include clamps 41 and locking screws 43. One side of each clamp 41 is provided with a slot body 410 having a rectangular through slot 411 that accommodates the wall thickness of steps 12 of ladder 1. An outer sidewall 412 of slot body 410 is higher than an inner sidewall 413. A nut seat 414 having a threaded bore is provided on the upper end face of inner sidewall 413. Locking screw 43 is threadedly connected to nut seat 414. The threadedly connected end portion of locking screw 43 abuts against sidewall 13 of step 12. A snap slot 415 that is snap-engaged with upright tube 31 of barrier 3 is provided at the other side of each clamp 41.

Upon mounting, slot body 410 of clamp 41 is inserted onto sidewall 13 of step 12 (as shown in FIG. 3B). By rotating locking screws 43, a threadedly connected end portions of locking screws 43 abut against sidewall 13 of steps 12, and connector 4 is fixed on steps 12. Then, snap slot 415 of clamps 41 are snap-engaged with upright tube 31 of barrier 3, and mounting of barrier 3 is complete.

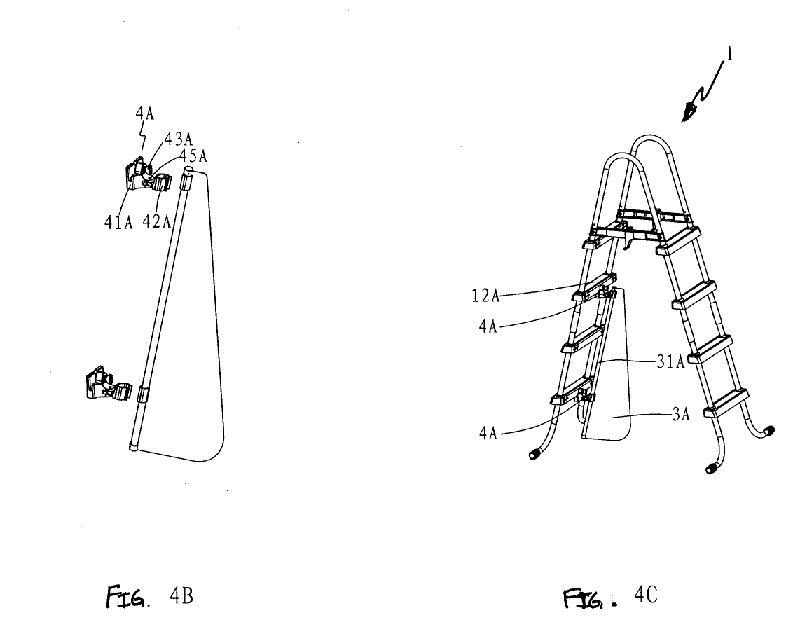

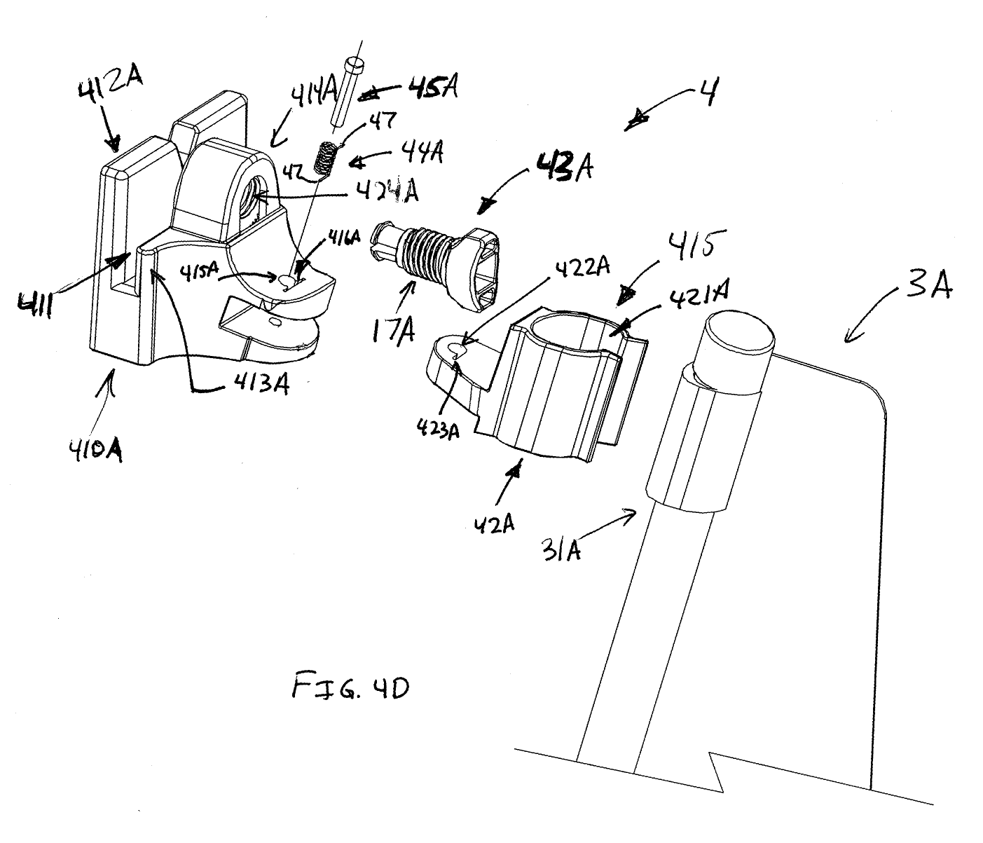

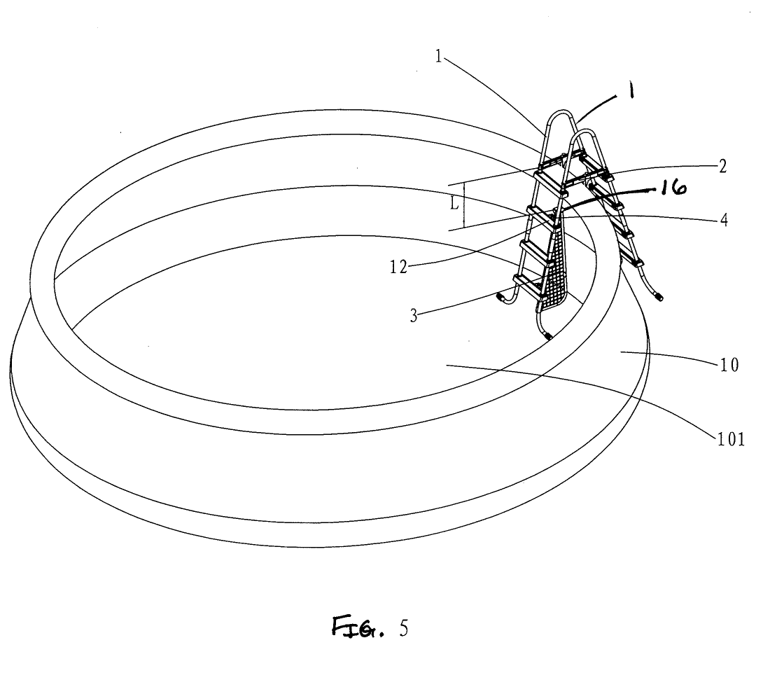

As shown in FIG. 4A and FIG. 4B, connector 4A is a swing-type connector 4A. Connector 4A comprises a left clamp 41A, a right clamp 42A, a locking screw 43A, a torsion spring 44A, and a pin 45A.

Left clamp 41A is provided with a slot body 410A having a rectangular through slot 411A that matches the wall thickness of steps 12A of ladder 1 (as shown in FIG. 4C). An outer sidewall 412A of slot body 410A is higher than an inner sidewall 413A. A nut seat 414A having a threaded bore 424A is provided on the upper end face of inner sidewall 413A as shown in FIG. 4D. Locking screw 43A is threadedly connected to nut seat 414A. Threadedly connected end portion 17A of locking screw 43A abuts against outer sidewall 412A.

A snap slot 421A of right clamp 42A is snap-engaged with upright tube 31A of barrier 3A (as shown in FIG. 4C). Left clamp 41A and right clamp 42A are pivotably connected together through a pin 45A, and said right clamp 42A may swing in relation to said left clamp 41A. Apertures 416A, 423A for receiving legs 47 of spring 44A are provided adjacent pin hole 415A of left clamp 41A and pin hole 422A of right clamp 42A. Torsion spring 44A covers pin 45A and is inserted within pin hole 415A of left clamp 41A. Legs 47 at one end of torsion spring 44A are positioned in straight aperture 416A adjacent to pin hole 415A of left gripper 41A, and leg 47 at other end of torsion spring 44A is positioned in slot 423A adjacent to pin hole 422A of right clamp 42A. Thus, a torsional restoring force for aligning left clamp 41A and right clamp 42A is generated.

The above mentioned barrier may be a framework with a mesh-like material tightened thereon (see FIG. 2), or a panel structure made of relatively soft materials (see FIG. 3B), which not only may serve the function of a barrier, but also may be easily pushed through water.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

### APPENDIX A

### BRIEF DESCRIPTION OF THE DRAWINGS

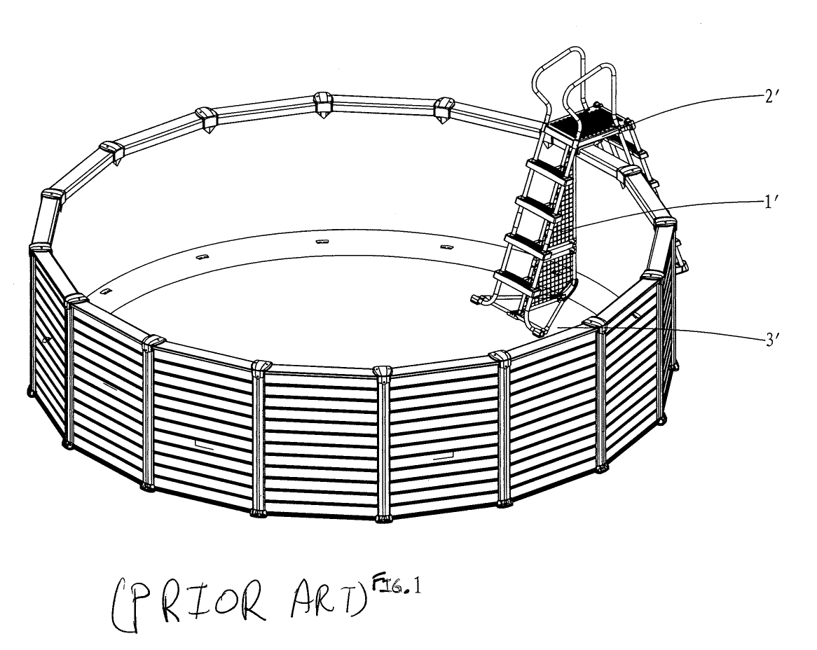

FIG. 1A is a perspective exploded view of the first embodiment of the present disclosure;

FIG. 1B is an assembled view similar to FIG. 1A of the first embodiment of the present disclosure;

FIG. 1C is a view illustrating the mounting of the first embodiment of the present disclosure in a pool;

FIG. 2A is a perspective exploded view of the second embodiment of the present disclosure;

FIG. 2B is an assembled view similar to FIG. 2A of the second embodiment of the present disclosure;

FIG. 2C is a view illustrating the mounting of the second embodiment of the present disclosure in a pool;

FIG. 3A is a perspective exploded view of the third embodiment of the present disclosure;

FIG. 3B is an assembled view similar to FIG. 1A of the third embodiment of the present disclosure;

FIG. 3C is a view illustrating the mounting of the third embodiment of the present disclosure in a framed pool; and

FIG. 3D is view illustrating the mounting of the third embodiment of the present disclosure in an inflatable pool.

### DETAILED DESCRIPTION

The first embodiment of the fixed means for fixing a ladder to a swimming pool 20 of the present disclosure is shown in FIG. 1A, FIG. 1B and FIG. 1C. The present disclosure comprises a fastening piece 1 and a locking screw 2. The upper portion of said fastening piece 1 is sleeve 11 acting as the connecting portion. The cavity of the sleeve 11 has a shape that matches with the shape of the top bar 10 of the ladder and may be connected to the top bar 10 of the ladder in a sliding manner. The lower portion of the fastening piece 1 is a positioning portion 12 that extends downwardly from one side of the sleeve 11 and bends horizontally outwardly at the end portion. A threaded bore 13 is provided on the top face of the sleeve 11. The locking screw 2 is threadedly connected within the threaded bore 13, and the threadedly connected end portion thereof may be abutted against the top bar of the ladder that passes through the cavity of the sleeve 11. Thus, the fastening piece 1 is fixed to the top bar 10. Upon use, there are two fastening pieces 1, each of which is respectively abutted against the upper edge of the swimming pool 20 from the outside of the upper edge of the swimming pool 20.

The second embodiment of the fixed means for fixing a ladder to a swimming pool 20′ of the present disclosure is shown in FIG. 2A, FIG. 2B and FIG. 2C. The present disclosure comprises a fastening piece 1′, a locking screw 2′ and an arc-shaped positioning strip 3′. The fastening piece 1′ is a sleeve 1′ acting as the connecting portion. The sleeve 1′ is partitioned into two cavities by a partition, that is, the upper cavity 11′ and the lower cavity 12′. The upper cavity 11′ has a shape that matches with the shape of the top bar 10′ of the ladder and may be connected to the top bar 10′ of the ladder in a sliding manner. A threaded bore 13′ is provided on the top face of the sleeve 1′. The locking screw 2′ is threadedly connected within the threaded bore 13′, and the threadedly connected end portion thereof may be abutted against the top bar 10′ of the ladder that passes through the cavity of the sleeve P. Thus, the fastening piece 1′ is fixed to the top bar 10′. The upper end of said arc-shaped positioning strip 3′ is connected within the lower cavity 12′ of the fastening piece 1′ and the lower portion of said arc-shaped positioning strip 3′ matches with the arc-shaped upper edge of the swimming pool 20′. Upon use, there are two arc-shaped positioning strips 3′, each of which is respectively abutted against the upper edge of the swimming pool 20′ from the outside of the upper edge of the swimming pool 20′.

The third embodiment of the fixed means for fixing ladder to swimming pool of the present disclosure is shown in FIG. 3A, FIG. 3B, FIG. 3C, and FIG. 3D. The present disclosure comprises a gripping strip 1″ and a locking piece 2″. The upper portion of said gripping strip 1″ is the connecting portion 11″ that is provided with a through hole 111″ and the lower portion thereof is the positioning portion 12″. The locking piece 2″ comprises a screw 21″, a gasket 22″, and a nut 23″. The screw 21″ passes through the through hole 111″ on the upper portion of the gripping strip 1″, the gasket 22″, and the through hole 101″ on the top bar 10″ of the ladder so as to be threadedly connected with the nut 23″ to fix the gripping strip 1″ on the top bar 10″ of the ladder. Upon use, there are four gripping strips 1′″, which are respectively abutted against the upper edge of the swimming pool 20″ from the inside and outside of the upper edge of the swimming pool 20″, thus fixing the ladder.

### APPENDIX B

### BRIEF DESCRIPTION OF THE DRAWINGS

FIG. 1 is a perspective view of the existing ladder;

FIG. 2 is a perspective exploded view of a barrier box;

FIG. 3 is a another perspective exploded view of the barrier box of FIG. 2;

FIG. 4 is a view showing the folding process of the barrier box of the present disclosure;

FIG. 5 is a view showing the barrier box of the present disclosure that is folded; and

FIG. 6 is a view illustrating the barrier box mounted on the ladder.

### DETAILED DESCRIPTION

As shown in FIG. 6, the present disclosure provides a step barrier structure for a swimming pool ladder, which comprises barrier boxes 1 and connecting pieces 2. As shown in FIG. 2, the barrier box 1 comprises four side walls 11, 12, 13, 14 , i.e. a first opposite side walls 12,14 and a second opposite side walls 11,13, and a bottom plate 15; wherein the four side walls 11, 12, 13, 14 are mutually connected to form a rectangular frame through hinge structures. The through holes 121, 122, 141, 142 are provided on the first opposite side walls 12, 14 of barrier box 1, which through holes are snap engaged with the connecting pieces 2. The first side walls 12, 14 are not connected to the bottom plate 15. The lower edges of the second side walls 11, 13 are connected to the bottom plate 15 to form a frame-shaped structure through the hinge structure. Two hinge structures are provided on the first side walls 12, 14, so the first side walls 12, 14 are foldable. The bottom plate 15 is provided thereon with a hinge structure in parallel with the edges that are connected to the side walls 11, 13, through which hinge structure, the bottom plate may be folded in half. Thus, the bottom plate 15 is also foldable (with reference to FIG. 4).

The barrier box 1 may be folded into the flat shape as shown in FIG. 5. Thus, not only is transportation facilitated, but also the bottom plate 15 of the barrier box 1 may be sized to closely fit within the space left between the steps 92, and upon fixing, the barrier box 1 is firstly disposed between the steps 92 in a state of being folded, then unfolded. Thus not only is the fixing thereof convenient, but also no gap is left between the two steps 92 after fixing.

To facilitate the fixing of the barrier 10, the upper surface of the side wall 11 of the barrier box 1 is concaved so as to form a groove 111. The connecting piece 2 comprises a U-shaped slot 21 and a circular snap 22. The circular snap 22 is provided on the extension portion from one side of the U-shaped slot 21. The U-shaped slot 21 may be snap engaged on a rail of the ladder 9, and the circular snap 22 may be engaged within the through holes 121, 122, 141, 142 of the side walls 12, 14 of the barrier box 1.

As shown in FIG. 3, with reference to FIG. 2, upon fitting, the circular snaps 22 of the four connecting pieces 2 are respectively engaged within the through holes 121, 122, 141, 142 of the side walls 12, 14 of the barrier box 21. Then, the U-shaped slots 21 on the connecting pieces 2 are snap engaged on the ladder rails 91 of a section 9 of the ladder (as shown in FIG. 6), with each barrier box 1 positioned between each two steps 92 on the section 9 of the ladder.

### APPENDIX C

### BRIEF DESCRIPTION OF THE DRAWINGS

FIG. 1 is a perspective exploded view of the first embodiment of the present. disclosure;

FIG. 2 is a view showing the assembly of the first embodiment of the present disclosure;

FIG. 3 is a perspective view showing the installation of the first embodiment of the present disclosure on the ladder;

FIG. 4 is a sectional view showing the installation of the first embodiment of the present disclosure on the ladder;

FIG. 5 is a perspective exploded view of the second embodiment of the present disclosure;

FIG. 6 is a view showing the assembly of the second embodiment of the present disclosure;

FIG. 7 is a view showing the process of installation the second embodiment of the present disclosure on the ladder;

FIG. 8 is a view showing the second embodiment of the present disclosure mounted on the ladder; and

FIG. 9 is an axonometric view of the clasp used in the second embodiment of the present disclosure.

### DETAILED DESCRIPTION

The first embodiment of the safety protection device for the plastic swimming pool according to the present disclosure is shown in FIG. 1. The safety protection device for the plastic swimming pool of the present disclosure comprises a plastic baffle plate 1. One side edge of the baffle plate 1 is welded to the inner sidewall of the plastic swimming pool 10. The other free edge 11 is abutted against and fixed at the inside of the section 21 of the ladder 2 that is disposed within the swimming pool. The baffle plate 1 may be made of the same flexible material as the plastic swimming pool 10, and the shape of the baffle plate is slightly smaller than the gap between the section 21 of the ladder 2 that is disposed within the swimming pool and the inner sidewall of the swimming pool 10.

To facilitate fixation, the free edge 11 of the baffle plate 1 is rolled inwardly and fused to form a channel tube into which the connecting rod 12 may be positioned (as shown in FIG. 2). Two connecting pieces 22 are connected on the section 21 on the side of the ladder 2 that is disposed within the plastic swimming pool 10, and the outside of the connecting piece 22 may be snap-engaged on said connecting rod 12 (as shown in FIG. 3). Said connecting pieces 22 may be connected on the side lever of the section 21, but
preferably disposed on the bottom side of the pedal or the inner side opposite to the baffle plate 1 in such a manner as not to hinder one stepping on the pedal.

As shown in FIG. 4, by installation the baffle plate 1, the gap between the section 21 on the side of the ladder 2 that is disposed within the plastic swimming pool 10 and the inner sidewall of the plastic swimming pool 10 may be obstructed.

The second embodiment of the present disclosure that is suitable for a large-size plastic swimming pool 10 is shown in FIG. 5.

The second embodiment comprises a baffle plate 1 that is welded to the inner sidewall of the plastic swimming pool 10′, a transitional baffle plate 2′ and a clasp 3′.

Said transitional baffle plate 2′ is provided between the free edge 11′ of the baffle plate 1′ and the section 41′ on the side of the ladder 4′ that is disposed within the plastic swimming pool 10′.

One side of said transitional baffle plate 2′ is connected to the section 41′ on the side of the ladder 4′ that is disposed within the plastic swimming pool 10′ through two connecting pieces 21′, and the other side of the transitional baffle plate 2′ is snap-engaged with the connecting rod 12′ on the free edge 11′ of the baffle plate 1′ through three clasps 3′.

As shown in FIG. 9, the clasp 3′ comprises two opening snap rings 31′ that are arranged symmetrically back-to-back. Upon assembly, three clasps 3′ are firstly snap engaged with the free edge of 11′ of the baffle plate 1 (as shown in FIG. 6), then snap engaged with the transitional baffle plate 2′ which is already connected on the section 41′ on the side of the ladder 4′ that is disposed within the plastic swimming pool 10′ (as shown in FIG. 7 and FIG. 8).

According to the preferred embodiment of the present disclosure a plastic baffle plate is welded to the inner sidewall of the plastic swimming pool; the shape of the baffle plate is slightly smaller than the gap between the section 21 of the ladder 2 that is disposed within the swimming pool and the inner sidewall of the plastic swimming pool 10; and with respect to a free edge of the section of the ladder that is disposed within the swimming pool, the baffle plate is provided with a plurality of connecting pieces that can be fixed on the section. If the gap between the inner sidewall of the swimming pool and the section of the ladder that is disposed within the swimming pool is much larger than the baffle plate, then a transitional baffle plate is additionally provided between the free edge of the baffle plate and the section of the ladder that is disposed within the swimming pool.

1. A swimming pool ladder with a barrier including
first and second ladder sections being positionable inside and outside a swimming pool, the first ladder section including a plurality of steps including an uppermost step,
a top support platform connecting upper portions of the first and second ladder sections, and
a triangular barrier having a first edge position adjacent the first ladder section and fixed to at least two steps with at least two connectors and a second edge positionable adjacent an inner sidewall of the swimming pool, a top end of the barrier is spaced apart from the top platform by a distance.

2. The swimming pool ladder with a barrier of claim 1, wherein the triangular barrier includes a framework with at least one of a mesh material tightened thereon or a soft panel structure.

3. The swimming pool ladder with barrier of claim 2, wherein the connector piece includes a clamp having a slot body and a locking screw, the slot body includes a rectangular through slot that accommodates a thickness of a step.

4. The swimming pool ladder with barrier of claim 3, wherein the slot body includes an outer wall and an inner wall cooperating to define the rectangular through slot, the outer sidewall is higher than the inner sidewall.

5. The swimming pool ladder with barrier of claim 4, wherein an upper face of the inner side wall includes a nut seat having a threaded bore, the locking screw is threadedly connected to the nut seat, and an end portion of the locking screw abuts against at least one of the steps.

6. The swimming pool ladder with barrier of claim 3, wherein the clamp includes a snap slot that is snap-engaged with a upright tube of the barrier.

7. The swimming pool ladder with a barrier of claim 1, wherein the connector includes a first clamp, a second clamp, a locking screw, a torsion spring, and a pin coupling the first clamp to the second clamp.

8. The swimming pool ladder with a barrier of claim 7, wherein the first clamp includes a rectangular through slot that accommodates the wall thickness of the step.

9. The swimming pool ladder with a barrier of claim 8, wherein the first clamp includes an outer wall and an inner wall that cooperate to define the rectangular through slot, the outer sidewall is higher than the inner sidewall.

10. The swimming pool ladder with a barrier of claim 9, wherein an upper end face of the inner wall includes a nut seat having a threaded bore, the locking screw is threadedly connected to the nut seat, and an end portion of the locking screw abuts against at least one of the steps.

11. The swimming pool ladder with a barrier of claim 7, wherein the second clamp includes a snap slot engaged with an upright tube of the barrier.

12. The swimming pool ladder with a barrier of claim 7, wherein the torsion spring includes legs and the first and second clamps include straight slots for receiving the legs of the torsion spring; the pin is covered by the torsion spring.
